(19) United States
(12) Patent Application Publication
(10) Pub. No.: US 2025/0123919 A1
(43) Pub. Date: Apr. 17, 2025

(54) DATA RECONCILIATION AND PROACTIVE DETECTION OF ERRORS IN DATA TRANSFER

(71) Applicant: Intuit Inc., Mountain View, CA (US)

(72) Inventors: John SAMUEL, Kerala (IN); Sandeep MEWARA, Karnataka (IN); Murari LAL, Karnataka (IN)

(73) Assignee: Intuit Inc., Mountain View, CA (US)

(21) Appl. No.: 18/484,613

(22) Filed: Oct. 11, 2023

(51) Int. Cl. G06F 11/07; G06F 11/34

(52) U.S. Cl. CPC G06F 11/0784; G06F 11/3476; G06F 2201/865

(57) ABSTRACT

Systems and methods for detecting errors in a data transfer uses a machine learning model to identify potential anomalies in the data transfer based on metadata. Mismatches between input data from the data transfer and output data after importing the data transfer may additionally be identified. User review and correction of data errors and potential anomalies identified using the machine learning model may be proactively prompted to ensure any errors or discrepancies are addressed before finalizing the import of the data transfer. User corrections are further used to retrain the machine learning model to enable continuous improvement and learning from the data transfer process.

### TECHNICAL FIELD

This disclosure relates generally to techniques and systems for data transfer between applications, and in particular to detection of errors in the data transfer.

### BACKGROUND

Every year millions of people, businesses, and organizations around the world use computer application to help manage aspects of their lives. From time to time, data must be transferred from one application to another. Data transfer, for example, may be the collection, replication, and transmission of a dataset from one application to another. An application, for example, may be any computer program that is designed to carry out a specific task, and may include word processors, media players, accounting programs, etc. The transfer of data between applications may be between different types of applications or between different versions of the same type of application, e.g., after an update of an application.

Data transfers sometimes suffer from errors, including the loss of information, inadvertent alteration of data, or improper formatting for the receiving application. Such errors may result in a critical data loss, the rejection of the data transfer, or improper operation of the application receiving the data transfer. Accordingly, it is desirable to reconcile and detect errors in a data transfer between applications.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable features disclosed herein.

One innovative aspect of the subject matter described in this disclosure can be implemented as a computer-implemented method for detecting errors in a data transfer, includes receiving the data transfer from a first application at a second application. The data transfer includes a first set of data and metadata associated with the first set of data. At least a portion of the data transfer is imported by the second application to generate a second set of data. Mismatched data is identified by comparing the first set of data and the second set of data and potential anomalies in the data transfer are identified with a machine learning model based on the metadata. User correction is prompted for any mismatched data in the data transfer and any potential anomalies in the data transfer. The data transfer imported by the second application is updated with any user corrections and the machine learning model is retrained based on the any user corrections.

Another innovative aspect of the subject matter described in this disclosure can be implemented as a system for detecting errors in a data transfer that includes one or more processors and a memory coupled to the one or more processors and storing instructions that, when executed by the one or more processors, cause the one or more processors to perform operations. The one or more processors may be caused to receive the data transfer from a first application at a second application. The data transfer includes a first set of data and metadata associated with the first set of data. The one or more processors may be further caused to import at least a portion of the data transfer by the second application to generate a second set of data. Mismatched data is identified by the one or more processors by comparing the first set of data and the second set of data and potential anomalies in the data transfer are identified by the one or more processors with a machine learning model based on the metadata. The one or more processors prompt user correction of any mismatched data in the data transfer and any potential anomalies in the data transfer. The one or more processors updates the data transfer imported by the second application with any user corrections and retrains the machine learning model based on the any user corrections.

Another innovative aspect of the subject matter described in this disclosure can be implemented as a system for detecting errors in a data transfer that includes an interface configured for receiving a data transfer from a first application at a second application. The data transfer includes a first set of data and metadata associated with the first set of data. The system includes a data transfer processor that is configured to import at least a portion of the data transfer by the second application to generate a second set of data. The system further includes an error detection processor configured to compare the first set of data and the second set of data to identify mismatched data in the data transfer from the first application to the second application and is configured to use a machine learning model to identify potential anomalies in the data transfer from the first application to the second application based on the metadata. The system further includes a user correction processor configured to prompt user correction of any mismatched data in the data transfer and any potential anomalies in the data transfer. The import of the at least the portion of the data transfer by the data transfer processor is updated with any user corrections. The system further includes a retraining processor that retrains the machine learning model based on the any user corrections.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 shows a block diagram of a computing system configured for detecting errors in a data transfer, according to some implementations.

FIG. 2 shows an example architecture of a system for detecting errors in a data transfer, according to some implementations.

FIG. 3 shows an illustrative flowchart depicting an example method for detecting errors in a data transfer, according to some implementations.

Like reference numbers and designations in the various drawings indicate like elements.

### DETAILED DESCRIPTION

Implementations of the subject matter described in this disclosure may be used for error detection during data transfers. In particular, systems and methods are described regarding the implementation of a machine learning model used to identify potential anomalies in a data transfer, correcting any errors in the data transfer based on user input, and to retrain the machine learning model based on the user input to enable continuous improvement and learning from the data transfer process.

Data transfers are used to move data between one or more nodes, referred to herein as applications. An application, for example, may be any computer node or program that is designed to carry out a specific task, and may include word processors, media players, accounting programs, etc. The transfer of data between applications may be between different types of applications or between different versions of the same type of application, e.g., after an update of an application. A data transfer is generally the collection, replication, and transmission of a dataset from one application to another. Data transfer, for example, may be transferred from a remote server to a local computer or between different types of applications or different versions (updates) of the same application. Data transfer may be accomplished directly or through the use of network-less environments, such as providing data that is stored in an internal storage device used by a first application to a second application, or by copying data an external storage device and then copying from that device to another.

Data transfers may suffer from errors, including the loss of information, inadvertent alteration of data, or improper formatting for the receiving application. Errors in the data transfer may be the result of the collection, replication, and transmission of a dataset or in discrepancies between the transmitting and receiving applications. Errors in the data transfer may be problematic due to a critical data loss, a rejection of the data transfer, or improper operation of the receiving application after importing the data transfer. Accordingly, identifying and correcting errors in the data transfer is necessary for proper operation of the computing system.

As discussed herein, to enhance the accuracy and reliability of a data transfer, a robust machine learning-based logic is used to detect errors or potential anomalies within specific fields in the dataset based on an analysis of the metadata associated with the data. As an example, during a data transfer, different types of fields may be classified based on their characteristics and may be identified using metadata. Fields in the dataset, for example, may include static fields, dynamic fields, default value fields, and calculated fields. Static fields are fields that remain constant and do not change over time, such as an identifier, e.g., taxpayer ID, and may be directly transferred without any modifications. Dynamic fields have values that may change over time, such as a user's wage or address, and accordingly, it may be essential to accurately update these fields during the transfer process to correctly reflect the current information. Default value fields are fields with assigned default values, which are unlikely, but may change over time, such as marital status or number of children. It may be important to consider any updates or changes made to default value fields during a data transfer to ensure that the most recent value is reflected in the destination application. Calculated fields are fields that are derived from calculations based on other fields, such as a tax amount. The calculated values in these fields may either remain the same during the transfer or may vary based on specific calculations. It may be important to accurately perform calculations during the data transfer process to maintain the integrity of the calculated fields. By considering such types of fields and ensuring their accurate transfer, users can effectively migrate data between applications while maintaining data consistency and reliability.

The machine learning model may be trained based on the history of previous data transfers to identify patterns and trends in data transfers and to classify fields in the dataset that may have potential anomalies, e.g., areas that require user correction. The history of previous data transfers may include data transfers for different accounts, i.e., data transfers associated with different users, that have previously encountered errors or potential rejections. Using the historical data and comparing the fields of the previous data transfers, fields within the data with anomalies may be identified. Leveraging the power of machine learning and historical data, the system may predict anomalies in the data transfer, which may result in problematic operation of the receiving application. The predictive capability allows users to proactively correct potential errors in a data transfer. A static model, using static rules, may be used along with the machine learning model to assist in the identification of potential anomalies in the data transfer. A user may be proactively prompted based on the identified potential anomalies to review and correct an errors in the associated data. The proactive approach of prompting user input on potential anomalies ensures that any potential errors or discrepancies are addressed before they impact the integrity of the transferred data and operation of the receiving application. Accordingly, errors may be minimized to improve accuracy of the data transfer to provide users with a seamless and reliable experience when transferring data between applications.

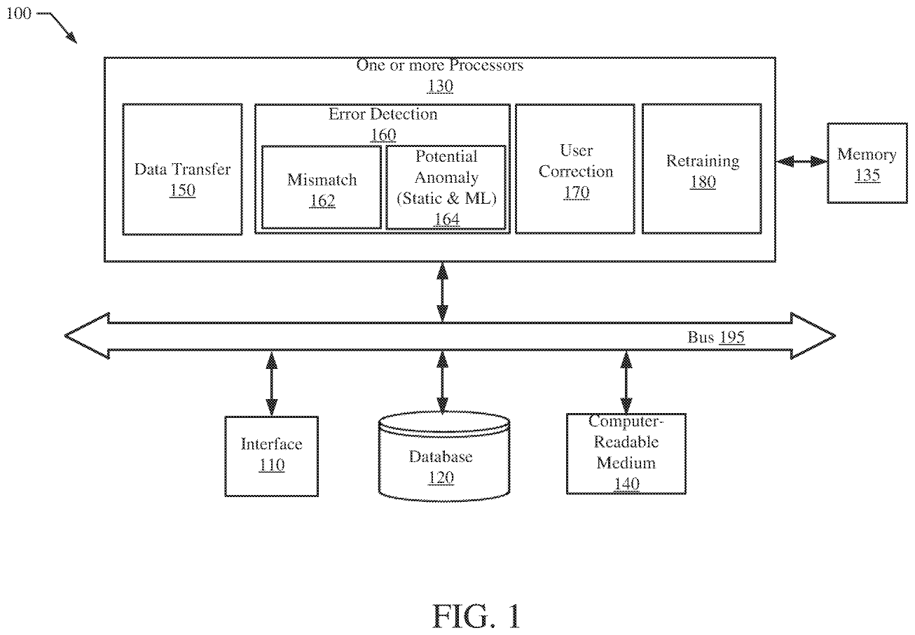

FIG. 1 shows an example computing system 100 configured for detecting errors in a data transfer, according to some implementations. The system 100 is shown to include an interface 110, a database 120, one or more processors 130, a memory 135 coupled to the one or more processors 130, and computer-readable medium 140. In some implementations, the various components of the system 100 may be interconnected by at least a data bus 195, which may be any known internal or external bus technology, including but not limited to ISA (Industry Standard Architecture), EISA (Extended Industry Standard Architecture), PCI (Peripheral Component Interconnect), PCI Express, NuBus, USB (Universal Serial Bus), Serial ATA (Serial Advanced Technology Attachment), or FireWire. In other implementations, the various components of the computer system 100 may be interconnected using other suitable signal routing resources, for example, the components may be distributed among multiple physical locations and coupled by a network connection.

The system 100 is configured for detecting errors in a data transfer between applications, which may be different types of applications or between different versions of the same type of application. The system 100, for example, may implement one or both of the applications. As an example, during tax preparation and filing, data is transferred from a first tax application, such as TurboTax Live® by Intuit® for a previous year, to a second tax application, such as TurboTax Live® by Intuit® for the current year. The system 100 may receive, via the interface 110, the data transfer from an external first application and may import the data transfer to an internal second application and detect errors in the data transfer. The system 100 may be perform the data transfer from an internal first application, e.g., via an interface including database 120 and/or computer-readable medium 140 and bus 195, import the data transfer to an internal second application and detect errors in the data transfer. In some implementations, one or both the first application and second application may be implemented by one or more external processors, which may be coupled to the one or more processors 130 via bus 195 or via interface 110.

The interface 110 may be one or more input/output (I/O) interfaces to obtain user inputs (such as via a web portal for a remote system or user interface devices for a local system) and, in some implementations, the data transfer from the first application. The system 100 may connect users to verify and correct any detected or potential errors in the data transfer, e.g., via the interface 110. Any errors detected in the data transfer, as well as any identified potential anomalies or errors, are provided to the user via the interface 110. The user, for example, may access system 100 via a web portal (such as through a web browser). An example interface 110 may include a wired interface or wireless interface to the internet or other means to communicably couple with other devices. For example, the interface 110 may include an interface with an ethernet cable or a wireless interface to a modem, which is used to communicate with an internet service provider (ISP) directing traffic to and from other devices (if system 100 is remote). If the system 100 is local, the interface 110 may include a display, a speaker, a mouse, a keyboard, or other suitable input or output elements that allow interfacing with the user.

The database 120 may store transferred data, including input data and metadata from the first application, and output data generated by the second application after importing the transferred data. In some implementations, the database 120 may include a relational database capable of presenting information (such as matches generated by the computing system 100) as data sets in tabular form and capable of manipulating the data sets using relational operators. The database 120 may use Structured Query Language (SQL) for querying and maintaining the database 120.

The one or more processors 130 may include one or more suitable processors capable of executing scripts or instructions of one or more software programs stored in system 100 (such as within the computer-readable medium 140 and/or memory 135) and that once programmed pursuant to instructions stored in memory operates as a special purpose computer. For example, the one or more processors 130 may be capable of executing one or more of the applications, as well as the data transfer processor 150, error detection processor 160, user correction processor 170, and retraining processor 180. The one or more processors 130 may include a single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the one or more processors 130 may include a combination of computing devices (such as a combination of a DSP and a microprocessor, a plurality of microprocessors, one or more microprocessors in conjunction with a DSP core, or any other such configuration). In some implementations, particular processes and methods may be performed by circuitry that is specific to a given function.

The memory 135 may be any memory (such as RAM, flash, etc.) that temporarily or permanently stores data, such as any number of software programs, executable instructions, machine code, algorithms, and the like that can be executed by the one or more processors 130 to perform one or more corresponding operations or functions. In some implementations, the memory 135 may be connected directly to or integrated with the one or more processors 130, e.g., as a processing in memory (PIM) chip.

Computer-readable medium 140 may be any computer-readable medium that participates in providing instructions to the one or more processors 130, directly or via memory 135, for execution, including without limitation, non-volatile storage media (e.g., optical disks, magnetic disks, flash drives, etc.), or volatile media (e.g., SDRAM, ROM, etc.). In some implementations, hardwired circuitry may be used in place of, or in combination with, software instructions to implement aspects of the disclosure. As such, implementations of the subject matter disclosed herein are not limited to any specific combination of hardware circuitry and/or software.

Computer-readable medium 140 may include various instructions, such as instructions for implementing an operating system (e.g., Mac OS®, Windows®, Linux, etc.). The operating system may be multi-user, multiprocessing, multitasking, multithreading, real-time, and the like. The operating system may perform basic tasks, including but not limited to recognizing input from input devices in the interface 110, sending output to display devices in the interface 110, keeping track of files and directories on computer-readable medium 140, controlling peripheral devices (e.g., disk drives, printers, etc.) which can be controlled directly or through an I/O controller, and managing traffic on bus 195. Computer-readable medium 140 may further include network communications instructions to establish and maintain network connections via the interface 110 (e.g., software for implementing communication protocols, such as TCP/IP, HTTP, Ethernet, telephony, etc.).

As illustrated, the one or more processors 130 is configured to perform various functions, as discussed herein. For example, the one or more processors 130 may be configured to operate as a data transfer processor 150 to perform the data transfer from a first application to a second application. The data transfer processor 150, for example, may be configured to receive the data transfer from the first application, which may include a first set of data, i.e., input data, and metadata associated with the first set of data. The first set of data, for example, may include a number of different fields, and the metadata is associated with each field, e.g., by classifying each of the field based on the likelihood of change, e.g., whether the field is static, dynamic, default value, or calculated. The data transfer processor 150 may be configured to import at least a portion of the data transfer, e.g., the first set of data, into the second application to generate a second set of data, i.e., output data, which may be stored in the database 120, memory 135, or computer-readable medium 140. The data transfer processor 150 may be further configured to update the import of the data transfer, e.g., based on user corrections to errors identified in the data transfer.

The one or more processors 130 may be further configured to operate as an error detection processor 160 to detect any errors or potential anomalies, e.g., data that is not mismatched but that potentially requires correction, in the data transfer. The error detection processor 160, for example, may be configured to operate as a mismatch processor 162 that identifies mismatches between the first set of data (input data) and the second set of data (output data). The identification of mismatched data, for example, may be based on a comprehensive comparison of the input data and the output data. The error detection processor 160, for example, may be further configured to operate as a potential anomaly processor 164 that identifies potential anomalies in the data transfer based on the metadata. The potential anomaly processor 164 may use a machine learning model to identify potential anomalies. The machine learning model may be a classification model or other suitable machine learning model such as an Xg-Boost classification model, an Xg-boost regression model, rule-based model or any other suitable machine learning model, which may be based on, e.g., any of the classification models listed above, nearest neighbors, control flow graphs, support vector machines, naïve Bayes, Bayesian Networks, value sets, hidden Markov models, or neural networks configured to generate probabilities. The machine learning model, for example, may be trained based on historical data obtained from previous data transfers, e.g., for other users or accounts, to identify common errors and patterns, and to identify potential anomalies in various fields in the data from the metadata. The potential anomaly processor 164 may further use a static model, e.g., using static rules, to identify potential anomalies in the data transfer.

The one or more processors 130 may be further configured to operate as a user correction processor 170 to prompt users to verify and/or correct any identified errors, e.g., any mismatches in the data identified by the mismatch processor 162 and any potential anomaly in the data identified by the potential anomaly processor 164. The user, for example, may be prompted from a remote computer via interface 110 to confirm or reject any mismatches and to verify or correct the values in any fields identified as including any potential anomalies. The user corrections may be provided by the user correction processor 170 to the data transfer processor 150 to update the import of the data transfer in the second application based on the user corrections.

The one or more processor 130 may be further configured to operate as a retraining processor 180 to retrain the machine learning model used by the potential anomaly processor 164 based on user input received from the user correction processor 170. The retraining of the machine learning model may be based on corrected fields including potential anomalies and, in some implementations, based on fields that include verified mismatched data. The corrections provided by the user may be used to further identify patterns and common errors found in data enabling continuous improvement and learning from the data transfer process. The retraining may update the deployed machine learning model used by the potential anomaly processor 164, e.g., for continuous training, or the deployed machine learning model may be periodically replaced with a retrained machine learning model.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. A computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship with each other.

One or more features or steps described herein may be implemented using an Application Programming Interface (API) and/or Software Development Kit (SDK), in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

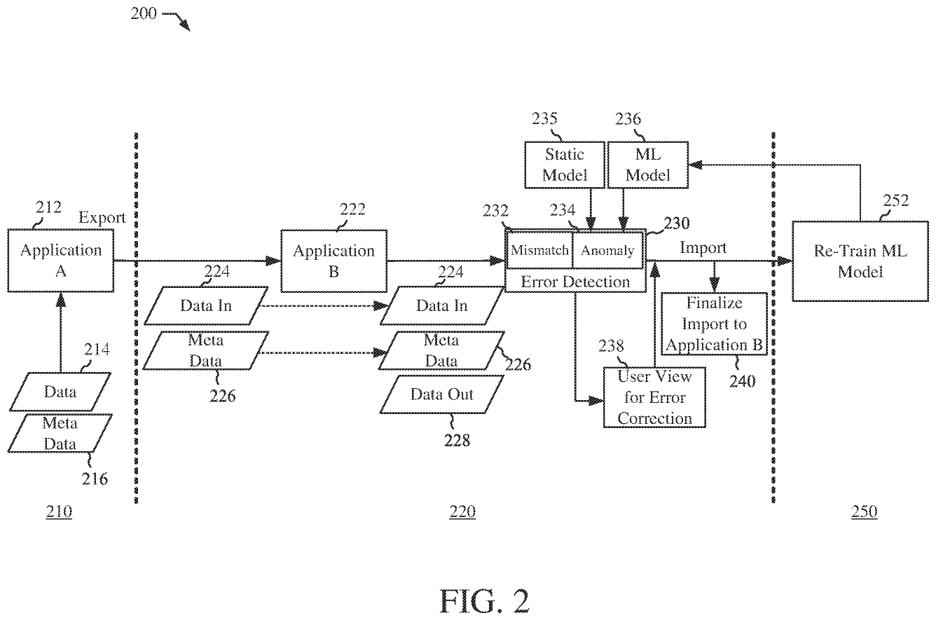

FIG. 2 shows an example architecture 200 for a system of detecting errors in a data transfer. The architecture 200, for example, identifies mismatches in the received data with respect to the transferred data and identifies potential anomalies in the data transfer based on metadata using a trained machine learning model and which is retrained based on any user corrections to the identified errors and potential anomalies. The architecture 200, for example, may be implanted by the computing system 100 illustrated in FIG. 1.

As illustrated, in an export procedure 210 during the data transfer process, application A 212 exports data 214 and metadata 216 to application B 222, and in an import procedure 220, application B 222 receives and imports the data and metadata. The application A 212 and application B 222 may be different versions of the same type of application, such as a word processor, media player, accounting program, tax preparation program, or any other application. In another implementation application A 212 and application B 222 may be different types of applications, which both operate on the same data, such as a word processor and spreadsheet application, etc.

While transferring data 214, it may be important that the data is accurately and reliable moved from application A 212 to application B 222. For example, in a non-limiting example, application A 212 may be a tax program for a particular year that is exporting tax data to application B 222, which may be the same tax program for the subsequent year. In such a tax-related example, it is readily apparent that migration of tax-related information from application A 212 to application B 222 should be accurate and complete. To improve error detection, in addition to identifying mismatches in the data itself, potential anomalies, e.g., errors, are identified by a trained machine learning model-based metadata associated with the data. Accordingly, during the data transfer process, application A 212 transfers metadata 216 associated with the data 214. The metadata 216, for example, may be associated with one or more of static fields, dynamic fields, or default value fields in the data 214. Static fields, for example, are fields that remain constant and do not change over time, such as identifying information, e.g., taxpayer ID, and may be directly transferred with no modification. Dynamic fields have values that may change over time, such as a physical address, wage, etc., which may need to be accurately updated from time to time to reflect currently correct information, e.g., updated at the time of the transfer for the current tax year in the tax-related example. Default value fields have default values that are assigned but that may also change from year to year, such as marital status, and may also need to be updated or changed from time to time to reflect currently correct information, e.g., update at the time of the transfer.

As illustrated in the import procedure 220, application B 222 receives data and metadata that is exported from application A 212, as input data 224 and metadata 226. It should be understood that the application B 222 may receive the input data 224 and metadata 226 directly from application A 212 or it may receive the input data 224 and metadata 226 from the application A 212 through one or more intermediary components, such as via a network, including the internet, or a storage device.

As illustrated, application B 222 receives and processes the input data 224 to generate output data 228 in response. The input data 224, metadata 226, and output data 228 are provided to error detection processor 230. The input data 224 and metadata 226 may be provided to the error detection processor 230 via application B 222 or may be stored in memory, e.g., memory 135 shown in FIG. 1, and provided to the error detection processor 230 via memory thereby bypassing application B 222, as illustrated by the dotted arrows in FIG. 2.

The error detection processor 230 includes a mismatch processor 232 to ensure that the transferred data that is received and processed by the application B 222, i.e., output data 228, matches the transferred data as original received by the application B 222, i.e., input data 224. The mismatch processor 232 performs a comprehensive comparison between the two data sets, i.e., input data 224 and output data 228, to identify any mismatches. The error detection processor 230 may send any identified discrepancies or mismatches between the two sets of data to a user view 238 for error correction for reconciliation. The user view 238 for error correction provides a dedicated reconcile view to users who may easily identify the fields that do not match and provide the correction. Thus, users are provided with a view that highlights the specific fields that exhibit inconsistencies, enabling users to correct any inaccuracies in the transferred data.

The error detection processor 230 further includes an anomaly processor 234 that uses a static model 235 and a trained machine learning model 236 to detect anomalies based on the metadata 226 that may occur during the data transfer process. The static model 235 employs one or more static rules to the data 224 and the metadata 226 to identify and flag fields in the output data 228 that include values that may potentially be classified as errors. By way of example, the static model 235 may employ a Data Type Rule, which checks if the data type of the transferred field is consistent with the expected data type. For example, if a field is expected to be a numeric value, but a non-numeric value is transferred, this would be flagged as an abnormality. In another example, the static model 235 may employ a Range Rule, which checks if the transferred field falls within the expected range of values. For example, if a field is expected to be between 0 and 100, but a value outside of this range is transferred, this would be flagged as an abnormality. In another example, the static model 235 may employ a Format Rule, which checks if the transferred field follows the expected format. For example, if a field is expected to be in a specific date format, but a different format is used, this would be flagged as an abnormality. In another example, the static model 235 may employ a Length Rule, which checks if the transferred field has the expected length. For example, if a field is expected to have a maximum length of 10 characters, but a longer value is transferred, this would be flagged as an abnormality. In another example, the static model 235 may employ a Mandatory Field Rule, which checks if mandatory fields are present and have been transferred. For example, if a required field is missing, this would be flagged as an abnormality. These and other static rules may be applied to both the data 224 and the metadata 226 to determine abnormality. By checking for these types of abnormalities, the system can proactively detect anomalies and initiate a review experience for users to carefully examine and correct any identified anomalies before importing the data into the destination application.

The machine learning model 236 analyzes and builds intelligence on the nature of discrepancies detected in the data. The machine learning model 236 is trained to identify patterns and common errors found in data, enabling continuous improvement and learning from the data transfer process. Feature metrics that may be used with the machine learning model 236, for example, are illustrated in Table 1. The machine learning model 236, for example, may be trained with Random Forest algorithm. Random Forest, for example, may be desirable for the Field Type metric, as it can handle both binary and multi-class classification problems, making it suitable for a field type metric. Random Forest additionally can handle both numerical and categorical data, making it suitable for the User Feedback metric. Random Forest may also handle missing data, which is important for user feedback data that may not be complete. Random Forest additionally can learn from patterns in historical data to make predictions about future data and is thus suitable for Prior Year History Associated metric. Random Forest can handle both binary and multi-class classification problems, making it suitable for the Mandatory Data metric. Random Forest can also handle missing data, which is important for mandatory data that may not be complete. Random Forest further can handle both numerical and categorical data, making it suitable for the Field Introduced Time metric. Random Forest can also handle missing data, which is important for field introduced time data that may not be complete. Thus, Random Forest is a good algorithm for handling the feature metrics of Table 1 because it can handle both numerical and categorical data, can handle missing data, and can learn from patterns in historical data to make predictions about future data. Additionally, or alternatively, the machine learning model 236 may use algorithms, such as K-Nearest Neighbors (KNN), Gradient Boosting, Xg-Boost classification, e.g., to predict 1/0 outcomes, an Xg-boost regression, e.g., to predict a probability or a continuous value, a rule-based model or any suitable machine learning model, which may be based on, e.g., any of the classification models listed above, nearest neighbors, control flow graphs, support vector machines, naïve Bayes, Bayesian Networks, value sets, hidden Markov models, or neural networks configured to generate probabilities.

TABLE 1

| | | Prior | | | |
|---|---|---|---|---|---|
| | User | Year | Output | Field | |
| | Feed- | History | data | Introduced | Category |
| Field Type | back | Associated | Data? | Time | (Output) |
| 1. Static | 1. Error | Yes/No | Yes/NO | 1. New | 1. Need Rec- |
| 2. Dynamic | 2. No | | | 2. Relatively | onciliation |
| 3. Default | Error | | | New | 2. Does |
| 4. Calc. | | | | 3. Relatively | Not require |
| | | | | old | Rec- |
| | | | | 4. Old | onciliation |

By incorporating the reconcile logic in the mismatch processor 232 and the machine learning based intelligence in the anomaly processor 234, the architecture 200 empowers users to ensure the accuracy of transferred data and provides valuable insights for ongoing enhancements and error prevention.

The anomaly processor 234 uses the machine learning model 236 to identify potential anomalies in the output data 228 based on the metadata. By leveraging insights to common errors and patterns learned from historical data, potential anomalies may be identified and corrected, if necessary, prior to completing the import of the data. Once anomalies are detected by the anomaly processor 234, using the static model 235 or the machine learning model 236, the error detection processor 230 initiates a review experience for users, e.g., via the interface 110 shown in FIG. 1, by sending potential anomalies to the user view 238 for error correction for examination and correction, if necessary. Additionally, the error detection processor 230 may provide any mismatches identified by the mismatch processor 232 and any potential anomalies identified by the anomaly processor 234 to update and finalize the import 240 of the transferred data to application B, and to a retraining procedure 250.

The user view 238 prompts user correction of any mismatches identified by the mismatch processor 232 and any potential anomalies identified by the anomaly processor 234. Any correction provided by a user using the user view 238 may be provided, e.g., via the interface 110 shown in FIG. 1, to update and finalize the import 240 of the transferred data to application B and to the retraining procedure 250.

The proactive approach to identifying and correcting potential anomalies in the import procedure 220 ensures that only accurate and reliable data is imported to application B 222, thereby minimizing the risk of errors or discrepancies. Addressing and correcting anomalies before importing the data into application B 222, ensures that the integrity and accuracy of the transferred information is improved. The proactive detection and review process significantly reduces the chances of errors or inconsistencies in the transferred data, providing users with a seamless and reliable experience.

In the retraining procedure 250, a retraining processor 252 retrains the machine learning model based on the identified mismatches and any user corrections provided by the user view 238. The identified mismatches and user corrections serves as a training set for supervised (re) training of the machine learning model to identify the patterns and common errors, thereby enabling continuous improvement and learning from the data transfer process. The machine learning model 236 may be updated with the retraining in order to improve identification of potential anomalies in subsequent data transfers.

Accordingly, the architecture 200 provides the ability to proactively detect anomalies, initiate a review experience, and enable data import after correcting anomalies, and continued improvement of error detection to enhance the accuracy and reliability of the data transfer process, ensuring high-quality data is seamlessly transferred between applications.

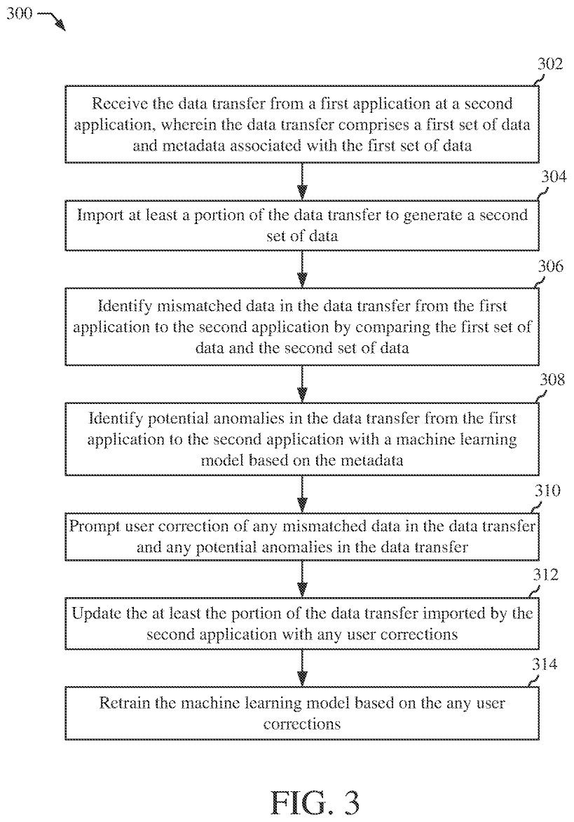

FIG. 3 shows an illustrative flowchart depicting an example method 300 for detecting errors in a data transfer, according to some implementations. The example method 300 is described as a computer-implemented method, e.g., performed by the computing system 100, such as by the one or more processors 130 executing instructions to perform operations associated with the error detection and described in reference to FIG. 2.

At 302, a data transfer is received from a first application at a second application, where the data transfer includes a first set of data and metadata associated with the first set of data. The first set of data may include a plurality of fields, and the metadata may be associated with the plurality of fields. Each of the plurality of fields may be classified based on a likelihood of change in the data in each respective field. For example, to characterize how each of the fields may be classified based on the likelihood of change of data in each respective field, a classification system may be used to assign a score or probability to each field based on its likelihood of change. Such a classification system may be created, e.g., by identifying the fields: that are included in the data from application A 212 (shown in FIG. 2), which may include fields such as name, address, income, etc. The likelihood of change for each field may next be determined, e.g., based on factors such as the frequency of updates to the field, the importance of the field for task-related purposes (e.g., tax-related purposes), and the potential impact of changes to the field on other fields. Once the likelihood of change for each field is determined, a score or probability is assigned to each field based on its likelihood of change. For example, a score of 1 may be assigned to fields that are unlikely to change, a score of 2 may be assigned to fields that are moderately likely to change, and a score of 3 may be assigned to fields that are highly likely to change. Each field may be classified based on their scores or probabilities. For example, classify fields with a score of 1 may be classified as static fields, fields with a score of 2 may be classified as dynamic fields, and fields with a score of 3 may be classified as default value fields. By using a classification system that assigns a score or probability to each field based on its likelihood of change, each field in the plurality of fields included in the data 214 and associate metadata 216 from application A 212 may be effectively classified accordingly, which may help ensure accurate and reliable movement of the data during the transfer process. The data transfer may be received via an interface and may be stored in a database, e.g., as discussed in reference to FIGS. 1 and 2.

At 304, at least a portion of the data transfer is imported by the second application to generate a second set of data. For example, the first set of data may be imported by the second application as input data by a data transfer processor to generate the second set of data as output data, e.g., as discussed in reference to FIGS. 1 and 2.

At 306, mismatched data is identified in the data transfer from the first application to the second application by comparing the first set of data and the second set of data. For example, an error detection processor may identify mismatched data based on a comparison of the first set of data, e.g., the input data, to the second set of data, e.g., the output data, as discussed in reference to FIGS. 1 and 2.

At 308, potential anomalies are identified in the data transfer from the first application to the second application with a machine learning model based on the metadata. The machine learning model, for example, may be trained based on historical data from a plurality of data transfers. Potential anomalies in the data transfer from the first application to the second application may be further identified based on a static model, e.g., applying static rules. For example, an error detection processor may identify potential anomalies, such as data in the data transfer that is not mismatched but that potentially requires correction, with a machine learning model based on the metadata, as discussed in reference to FIGS. 1 and 2.

At 310, user correction is prompted for any mismatched data in the data transfer and any potential anomalies in the data transfer. User correction may be prompted by identifying fields that include at least one of mismatched data and potential anomalies and requesting user verification or correction of the data in the identified fields. For example, a user correction processor may be used to prompt the user correction, as discussed in reference to FIGS. 1 and 2.

At 312, the at least the portion of the data transfer imported by the second application is updated with any user corrections. For example, the data transfer processor may update the data transfer based on user corrections received via the user correction processor, discussed in reference to FIGS. 1 and 2.

At 314, the machine learning model is retrained based on the any user corrections. Retraining the machine learning model may be further based on at least one of the any mismatched data in the data transfer and the any potential anomalies in the data transfer. The retraining of the user corrections, for example, may be performed by a retraining processor as discussed in reference to FIGS. 1 and 2.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally in terms of functionality, and illustrated in the various illustrative components, blocks, modules, circuits and processes described above. Whether such functionality is implemented in hardware or software depends upon the particular application and design constraints imposed on the overall system.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A computer-implemented method for detecting errors in a data transfer, comprising:
receiving the data transfer from a first application at a second application, wherein the data transfer comprises a first set of data and metadata associated with the first set of data;
importing at least a portion of the data transfer by the second application to generate a second set of data;
identifying mismatched data in the data transfer from the first application to the second application by comparing the first set of data and the second set of data;
identifying potential anomalies in the data transfer from the first application to the second application with a machine learning model based on the metadata;
prompting user correction of any mismatched data in the data transfer and any potential anomalies in the data transfer;
updating the at least the portion of the data transfer imported by the second application with any user corrections; and
retraining the machine learning model based on the any user corrections.

2. The computer-implemented method of claim 1, wherein the first set of data comprises a plurality of fields, wherein the metadata is associated with the plurality of fields.

3. The computer-implemented method of claim 2, wherein each of the plurality of fields are classified based on a likelihood of change in the data in each respective field.

4. The computer-implemented method of claim 1, wherein the potential anomalies comprise data that is not mismatched but that potentially requires correction.

5. The computer-implemented method of claim 1, wherein identifying potential anomalies in the data transfer from the first application to the second application is further based on a static model.

6. The computer-implemented method of claim 1, wherein prompting user correction of any mismatched data in the data transfer and any potential anomalies in the data transfer comprises identifying fields that include at least one of mismatched data and potential anomalies and requesting verification or correction of data in the identified fields.

7. The computer-implemented method of claim 1, wherein the machine learning model is trained based on historical data from a plurality of data transfers.

8. The computer-implemented method of claim 1, wherein retraining the machine learning model is further based on at least one of the any mismatched data in the data transfer and the any potential anomalies in the data transfer.

9. A system for detecting errors in a data transfer, comprising:
one or more processors; and
a memory coupled to the one or more processors and storing instructions that, when executed by the one or more processors, cause the one or more processors to perform operations comprising:
receive the data transfer from a first application at a second application, wherein the data transfer comprises a first set of data and metadata associated with the first set of data;
import at least a portion of the data transfer by the second application to generate a second set of data;
identify mismatched data in the data transfer from the first application to the second application by comparing the first set of data and the second set of data;
identify potential anomalies in the data transfer from the first application to the second application with a machine learning model based on the metadata;
prompt user correction of any mismatched data in the data transfer and any potential anomalies in the data transfer;
update the at least the portion of the data transfer imported by the second application with any user corrections; and
retrain the machine learning model based on the any user corrections.

10. The system of claim 9, wherein the first set of data comprises a plurality of fields, wherein the metadata is associated with the plurality of fields.

11. The system of claim 10, wherein each of the plurality of fields are classified based on a likelihood of change in the data in each respective field.

12. The system of claim 9, wherein the potential anomalies comprise data that is not mismatched but that potentially requires correction.

13. The system of claim 9, wherein the one or more processors is configured to identify potential anomalies in the data transfer from the first application to the second application further based on a static model.

14. The system of claim 9, wherein the one or more processors is configured to prompt user correction of any mismatched data in the data transfer and any potential anomalies in the data transfer by being configured to identify fields that include at least one of mismatched data and potential anomalies and requesting verification or correction of data in the identified fields.

15. The system of claim 9, wherein the machine learning model is trained based on historical data from a plurality of data transfers.

16. The system of claim 9, wherein the one or more processors is configured to retrain the machine learning model further based on at least one of the any mismatched data in the data transfer and the any potential anomalies in the data transfer.

17. A system for detecting errors in a data transfer, comprising:
an interface configured for receiving a data transfer from a first application at a second application, wherein the data transfer comprises a first set of data and metadata associated with the first set of data;
a data transfer processor configured to import at least a portion of the data transfer by the second application to generate a second set of data;
an error detection processor configured to compare the first set of data and the second set of data to identify mismatched data in the data transfer from the first application to the second application and configured to use a machine learning model to identify potential anomalies in the data transfer from the first application to the second application based on the metadata;
a user correction processor configured to prompt user correction of any mismatched data in the data transfer and any potential anomalies in the data transfer, wherein the import of the at least the portion of the data transfer by the data transfer processor is updated with any user corrections; and
a retraining processor that retrains the machine learning model based on the any user corrections.

18. The system of claim 17, wherein the first set of data comprises a plurality of fields, wherein the metadata is associated with the plurality of fields.

19. The system of claim 17, wherein error detection processor is configured to identify potential anomalies in the data transfer from the first application to the second application further based on a static model.

20. The system of claim 17, wherein the machine learning model is trained based on historical data from a plurality of data transfers.
